(19) United States
(12) Patent Application Publication
(10) Pub. No.: US 2004/0126502 A1
(43) Pub. Date: Jul. 1, 2004

(54) Method of fabricating an aluminum nitride (A1N) substrate

(75) Inventors: Marc Ferrato, rue de Bellevue (FR); Alain Petitbon, rue de la T ur (FR); Jean Jarrige, rue Pierre Ragot (FR)

Correspondence Address: SUGHRUE MION, PLLC, 2100 PENNSYLVANIA AVENUE, N.W., SUITE 800, WASHINGTON, DC, 20037, US

(73) Assignee: ALSTOM

(21) Appl. No.: 10/661,476

(22) Filed: Sep. 15, 2003

(30) Foreign Application Priority Data
Sep. 26, 2002 (FR) 02 11 898

(51) Int. Cl. B05D 1/08

(52) U.S. Cl. 427/446; 427/376.1

(57) ABSTRACT

A method of fabricating an aluminum nitride (AlN) substrate, wherein the substrate is obtained by spraying a powder onto a support at a high temperature and at a high speed, the powder including AlN grains covered with a layer of an oxide precursor chosen from oxide precursors yielding an oxide forming a liquid phase around the AlN grains during spraying.

### BACKGROUND OF THE INVENTION

1. Field of the Invention

The invention relates to a method of fabricating an aluminum nitride (AlN) substrate and in particular to a fabrication method for producing a thin substrate.

2. Description of the Prior Art

Because they are electrically insulative and good conductors of heat, AlN substrates are widely used to support power electronic components. They are usually sintered and are commercially available with a minimum thickness of 0.635 mm, for reasons of mechanical strength and of deformation during high temperature curing. An AlN substrate this thick can withstand voltages of several tens of kilovolts and is suitable for high power applications such as rail traction. However, a thickness of 0.635 mm is excessive for low-voltage applications, such as electric buses, where the additional thickness of the AlN substrate compared to the thickness necessary to withstand the voltage becomes a disadvantage from the cost and thermal resistance points of view.

Accordingly, an object of the present invention is to propose a method of fabricating an AlN substrate, in particular for producing AlN substrates from 0.1 mm to 0.5 mm thick.

### SUMMARY OF THE INVENTION

The invention provides a method of fabricating an aluminum nitride (AlN) substrate. According to the invention, the substrate is obtained by spraying a powder onto a support at a high temperature and at a high speed, the powder including AlN grains covered with a layer of an oxide precursor chosen from oxide precursors yielding an oxide forming a liquid phase around the AlN grains during spraying.

According to another feature of the invention, the powder is sprayed by means of a plasma torch.

According to a further feature of the invention, the powder is sprayed by means of a flow of air associated with an oxyacetylene torch.

According to another feature of the invention, the method includes the following successive steps:

dissolving an yttrium oxide precursor in an alcohol,

dispersing fine pure AlN powder in the solution previously obtained with vigorous agitation,

atomizing the suspension thus obtained in an inert atmosphere to obtain the granulated powder, and

spraying the powder onto the support.

According to another feature of the invention, the oxide is a rare earth oxide.

According to a further feature of the invention, the oxide precursor is an yttrium oxide precursor and the AlN powder obtained after atomization includes 2% to 3% by weight of yttrium oxide.

According to a further feature of the invention, the yttrium oxide precursor is yttrium isopropionate dissolved in propanol.

According to a further feature of the invention, the substrate is obtained by a plurality of passes over the support as a function of the required thickness.

According to a further feature of the invention, the support is a metal support and is cooled by jets of compressed air during the step of spraying AlN powder.

According to a further feature of the invention, the AlN substrate obtained by spraying AlN powder onto the support is annealed at a low temperature to relieve residual stresses between the support and the AlN ceramic.

Objects, aspects and advantages of the present invention will be better understood from the following description of one particular embodiment of the invention offered by way of nonlimiting example.

### DETAILED DESCRIPTION OF THE PREFERRED EMBODIMENTS

In a first phase of the method, AlN powder which can be sprayed by means of a plasma torch is produced by the following successive steps:

dissolving an yttrium oxide (Y₂O₃) precursor such as yttrium isopropionate or yttrium isopropoxide in isopropanol, with agitation,

dispersing fine pure AlN powder having a grain diameter of the order of 2 μm to 3 μm in the solution obtained in the preceding step to obtain an AlN slip containing the equivalent of 2% to 3% yttrium oxide, by grinding or by vigorous agitation, for example by means of a turbine, using a stabilizing agent or a surfactant so that the suspension remains stable up to the point of atomization,

atomizing the slip obtained previously in an inert atmosphere using an atomizer, the temperature and the spraying rate of the atomizer being adjusted so that the hollow spheres obtained are not crushed on the walls of the atomizer; this kind of atomization produces a powder formed of hollow spheres whose diameter is from 40 μm to 150 am, the hollow spheres consisting of AlN grains covered with a thin layer of yttrium oxide precursor and clumped by atomization, and

optionally screening the atomized powder to eliminate fractions that are too fine or too coarse and retain only hollow AlN spheres whose diameter is from 50 μm to 100 μm.

In a second phase of the method, the AlN powder obtained in the above manner is sprayed by means of a plasma torch onto a metal, for example aluminum, support, which is cooled by jets of compressed air on its opposite face to maintain an equilibrium temperature of the order of 150° C. The plasma torch can be a plasma arc torch, for example, whose temperature can be as high as 15 000 K, or an induction plasma torch with a temperature of a few thousand ° C. The spherical grains of AlN are sprayed into the plasma with a variable flowrate and reach the cooled metal support partly molten, at a speed close to the speed of sound, to form a somewhat dense layer. During this spraying phase, the AlN grains are protected from oxidation by the yttrium oxide precursor, which is decomposed in the plasma to yield the oxide and to react with the AlN to generate an yttrium aluminum garnet (YAG) phase. The number of passes of the plasma torch over the metal support is a function of the surface area and the required thickness of the AlN substrate, each pass depositing from 40 μm to 60 μm of AlN and a homogeneous surface being produced by partially overlapping the successive sweeps.

In a variant of the fabrication method according to the invention, the powder is sprayed by means of a flow of air through the flame of an oxyacetylene torch so that the powder is sprayed onto the support at a high speed and at a high temperature.

To encourage adhesion of the AlN deposit during thermal cycling, an attachment sublayer can be produced on the metal support before spraying the AlN. In the case of an aluminum support, for example, in order not to incur an excessive penalty in terms of cost and thermal resistance, the attachment sublayer can be a thin layer of oxide obtained by anodization and having a thickness of a few micrometers. In the case of a copper support, the support is preferably plated with nickel by a chemical method and possibly lightly plated with chromium.

In a subsequent phase of the method, the AlN substrate on its metal support is advantageously annealed at a low temperature to relieve residual stresses due to the difference between the coefficients of thermal expansion of the support and the AlN ceramic.

A fabrication method of the above kind produces an AlN substrate whose thickness can be from 0.1 mm to 0.5 mm and which is therefore optimized for use as a support for electronic components in low-voltage applications.

To improve the surface roughness of the AlN substrate obtained in the above manner, for example for applications in power electronics in which it is necessary to plate the surface of the ceramic substrate with copper in order to braze semiconductor components to it, the surface of the AlN substrate can advantageously be activated by an excimer laser to smooth the surface, after which copper can be deposited electrolytically on the activated areas.

Of course, the invention is in no way limited to the embodiment described and shown, which has been offered by way of example only and can be modified without departing from the field of protection of the invention, in particular from the point of view of the composition of the various component parts or by substituting technical equivalents.

Thus in a variant of the method the yttrium oxide precursor used can be hexafluoroacetylacetonate, dissolved in tetrahydrofuran during the first step of the phase of preparing the AlN powder.

Thus, in other embodiments of the method according to the invention, the oxide precursor used can be chosen from precursors of oxides of cerium, samarium, calcium or lanthanides. For example, the oxide precursor chosen can be samarium acetylacetonate, dissolved in an organic solvent such as tetrahydrofuran.

There is claimed:

1. A method of fabricating an aluminum nitride (AlN) substrate, wherein said substrate is obtained by spraying a powder onto a support at a high temperature and at a high speed, said powder including AlN grains covered with a layer of an oxide precursor chosen from oxide precursors yielding an oxide forming a liquid phase around said AlN grains during spraying.

2. The fabrication method claimed in claim 1, wherein said powder is sprayed by means of a plasma torch.

3. The fabrication method claimed in claim 1, wherein said powder is sprayed by means of a flow of air associated with an oxyacetylene torch.

4. The method claimed in claim 1 of producing an aluminum nitride (AlN) substrate, which includes said following successive steps:
dissolving an oxide precursor in said form of an organometallic substance in an organic solvent,
dispersing fine pure AlN powder in said solution previously obtained with vigorous agitation,
atomizing said suspension thus obtained in an inert atmosphere to obtain said granulated powder, and
spraying said powder onto said support.

5. The method claimed in claim 1 of producing an aluminum nitride (AlN) substrate, wherein said oxide is a rare earth oxide.

6. The method claimed in claim 4 of producing an aluminum nitride (AlN) substrate, wherein said oxide precursor is an yttrium oxide precursor and said AlN powder obtained after atomization includes said equivalent of 2% to 3% by weight of yttrium oxide.

7. The method claimed in claim 6 of producing an aluminum nitride (AlN) substrate, wherein said yttrium oxide precursor is yttrium isopropionate dissolved in propanol.

8. The method claimed in claim 1 of producing an aluminum nitride (AlN) substrate, wherein said substrate is obtained by a plurality of passes over said support as a function of said required thickness.

9. The method claimed in claim 1 of producing an aluminum nitride (AlN) substrate, wherein said support is a metal support and is cooled by jets of compressed air during said step of spraying AlN powder.

10. The method claimed in claim 1 of producing an aluminum nitride (AlN) substrate, wherein said AlN substrate obtained by spraying AlN powder onto said support is annealed at a low temperature.
